(19) United States
(12) Patent Application Publication
(10) Pub. No.: US 2023/0289913 A1
(43) Pub. Date: Sep. 14, 2023

(54) GOOD TRANSFERRING SYSTEM

(71) Applicant: Lior Klein, Calabasas, CA (US)

(72) Inventor: Lior Klein, Calabasas, CA (US)

(21) Appl. No.: 17/692,141

(22) Filed: Mar. 10, 2022

(51) Int. Cl. G06Q 50/28; G06Q 30/06; G06Q 30/02

(52) U.S. Cl. CPC G06Q 50/28; G06Q 30/0621; G06Q 30/0282

(57) ABSTRACT

A good transfer method includes obtaining, at a good transfer platform, an available good transfer option including transferor availability and dimensions of a good transfer space, obtaining, at the good transfer platform, a good transfer request of a user including one or more goods to be transferred from a pick-up location to a drop-off location, dimensions of the one or more goods, and a pick-up time associated with the one or more goods, presenting, via the good transfer platform, the available good transfer option to the user, obtaining, at the good transfer platform, a selection of the available good transfer option to fulfill the good transfer request of the user, and notifying, via the good transfer platform, the good transferor of the pick-up location, the pick-up time, and the drop-off location of the good information of the good transfer request.

### BACKGROUND

Shipping rates associated with goods are steadily increasing and consumers are faced with limited shipping options. Meanwhile, the conventional model of shipping goods remains unchanged and a user who wants to ship goods from one location to another typically must choose from a limited number of conventional providers who transport goods nationwide.

For users that choose to hire local conventional providers who transport goods on a local basis, the process from start to finish is inefficient. For example, finding local conventional providers is difficult, and, once one is found, the user typically has to provide details of the shipment over a telephone call, haggle over shipping costs, and blindly trust that the local conventional provider will perform as required.

### SUMMARY OF THE INVENTION

The present disclosure provides a good transfer system and method that allows good transferors to connect with users who want to transfer one or more goods from one location to another location in an optimal way. The techniques associated with the good transfer system and method of the present disclosure reduce inefficiencies of conventional techniques and provide a convenient, widely available, and cost effective way for good transferors to increase transfer of goods while providing users who want to transfer goods from one location to another with easy access to potential good transferors.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a flow diagram of an exemplary implementation of a good transfer method in accordance with one aspect of the present disclosure.

FIG. 2 illustrates an exemplary good transfer system in accordance with one aspect of the present disclosure.

### DETAILED DESCRIPTION

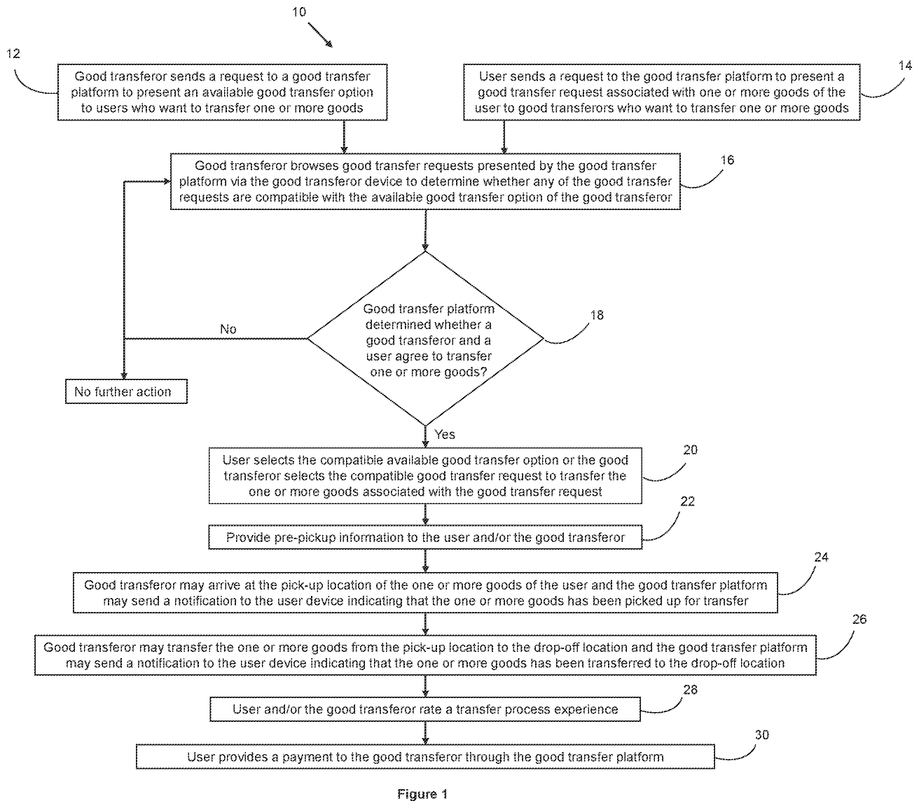

FIG. 1 illustrates a diagram of an exemplary implementation of a method 10 for transferring goods. Generally, the method 10 may be implemented to match good transferors with users who want to transfer one or more goods (e.g., metals, stones, wood, plastic, and/or any suitable good) from one location to another location. Transferring goods in this context may mean, for example, a person in the possession of a vehicle transporting construction materials or any other goods from a local hardware store or any pickup location to a home or site of a user or any other drop off location. The person (i.e., good transferor) or vehicle may be associated with the hardware store or pickup location but most often the person and/or vehicle acts independently, i.e., not associated with the hardware store/pickup location or any other commercial entity. The person may be an unassociated person simply seeking to offer her services for cash compensation. This person may use the systems and methods disclosed herein to make her services available to a relatively wide audience, to users seeking assistance in transferring goods from a first location (e.g., the hardware store) to another location (e.g., the user's home or construction site.) To accomplish this, the method 10 may include a good transfer platform, a good transferor device, and a user device.

The good transfer platform may be a server, a computing device, a cloud server, a cloud computing device and/or the like. The good transfer platform may receive, generate, store, process, and/or provide information associated with transferring one or more goods.

The good transferor device may be a computing device such as, for example, a mobile phone, a smartphone, a computer and/or the like. The good transferor device may interact with the good transfer platform to transfer one or more goods. For example, the good transferor device may send information to, and receive information from, the good transfer platform to transfer one or more goods.

The user device may be a computing device such as, for example, a mobile phone, a smartphone, a computer and/or the like. The user device may interact with the good transfer platform to transfer one or more goods. For example, the user device may send information to, and receive information from, the good transfer platform to transfer one or more goods.

The method 10 will be described where a good transferor wants to perform good transfer services for a user and where a user has one or more goods that the user wants to be transferred by the good transferor.

At 12, the good transferor may send a request to the good transfer platform to present an available good transfer option to users who want to transfer one or more goods. For example, if the good transferor is not already registered with the good transfer platform, the good transferor may use an application running on the good transferor device to register with the good transfer platform by providing identifying and/or other personal information. The good transferor may request access to the good transferor platform and the good transferor platform may authenticate the good transferor to allow access to the good transfer platform. The good transferor may enter an input, via the good transferor device, that indicates a request to the good transfer platform to present an available good transfer option to users who want to transfer one or more goods and the good transferor device may send the input to the good transfer platform. The request may include available good transfer option information (also referred to as “transferor information”), such as, for example, good transferor availability (e.g., current availability and/or future availability), good transfer requirements/limitations, good transfer space characteristics (e.g., dimensions, materials, etc.), good transfer pricing, good transfer distance requirements, good transfer distance limitations, and/or any other suitable information.

At 14, the user may send a request to the good transfer platform to present a good transfer request associated with one or more goods of the user to good transferors who want to transfer one or more goods. For example, if the user is not already registered with the good transfer platform, the user may use an application running on the user device to register with the good transfer platform by providing identifying and/or other personal information. The user may request access to the good transferor platform and the good transferor platform may authenticate the user to allow access to the good transfer platform. The user may enter an input, via the user device, that indicates a request to the good transfer platform to present a good transfer request associated with one or more goods of the user to good transferors who want to transfer one or more goods and the user device may send the input to the good transfer platform. The request may include good transfer request information (also referred to as “good information”), such as, for example, good pick-up location, good drop-off location, good pick-up time, good characteristics (e.g., dimensions, quantity, etc.), good transfer time period, total good transfer distance, good transfer budget, and/or any other suitable information.

At 16, the good transfer platform may present the available good transfer option to users who want to transfer one or more goods. For example, the good transfer platform may process the information associated with the good transferor request and store the processed information in an available good transfer option database as an available good transferor option. The available good transferor option stored in the available good transfer option database may be made accessible to users through the good transfer platform (e.g., the user may access the available good transferor information through the application running on the user device). Also at 16, the good transfer platform may present the good transfer request to good transferors who want to deliver one or more goods. For example, the good transfer platform may process the information associated with the good transfer request and store the processed information in a good transfer request database as a good transfer request. The good transfer request stored in the good transfer request database may be made accessible to good transferors through the good transfer platform (e.g., the good transferor may access the good transfer request through the application running on the good transferor device).

At 18, the good transfer platform determines whether a good transferor and a user agree to transfer one or more goods. An exemplary implementation where a good transferor and a user agree to transfer one or more goods will be described where the one or more goods is two hundred pieces of metal weighing two thousand pounds. The user may access the good transfer platform and may use the user device to send a good transfer request associated with the two hundred pieces of metal to the good transfer platform (e.g., as described above). In this example, the good transfer request may include good information associated with the one or more goods to be transferred, such as, for example, a length of the longest metal piece (e.g., eight feet), a total width of the metal pieces (e.g., four feet) a gross weight of the metal pieces (i.e., two thousand pounds), a quantity (i.e., two hundred), a required transfer deadline (e.g., the metal pieces must be delivered within one week), a pick-up location (e.g., a home address), a drop-off location (e.g., another home address), a total transfer distance (25 miles), and a budget (e.g., $1000).

The user may browse available good transfer options presented by the good transfer platform via the user device to determine whether any of the available good transfer options are compatible with the good transfer request where an available good transfer option is compatible with the good transfer request when the available good transfer option can meet all requirements of the good transfer request.

In this example, a first available good transfer option may include available good transfer option information, such as, for example, availability (e.g., capable of delivering one or more goods within a week), good transfer requirements/limitations (e.g., a longest good of the one or more goods must have a length of eight feet or less and a weight of the one or more goods must be two thousand pounds or less), good transfer space characteristics (e.g., a length (eight and a half feet), a width (6 feet), and a material (metal) of a transfer space that may carry the one or more goods), good transfer pricing (e.g., $950 for up to two thousand pounds), and good transfer distance limitations (e.g., total transfer distance must be less than thirty miles).

In this example, a second available good transfer option may include available good transfer option information, such as, for example, availability (e.g., capable of delivering one or more goods within a week), good transfer requirements (e.g., a longest good of the one or more goods must have a length of seven feet or less), good transfer limitations (a weight of the one or more goods must be one thousand pounds or less), good transfer space characteristics (e.g., a length (five and a half feet), a width (5 feet), and a material (aluminum) of a transfer space that may carry the one or more goods), good transfer pricing (e.g., $950 for up to one thousand pounds), and good transfer distance limitations (e.g., total transfer distance must be less than twenty miles).

In this example, the first available good transfer option would be compatible with the good transfer request as all conditions associated with the first available good transfer option and the good transfer request are compatible while the second available good transfer option would be incompatible with the good transfer request as multiple conditions associated with the second available good transfer option and the good transfer request are not met. Accordingly, the user may determine that the first available good transfer option is compatible with the good transfer request and the method 10 may turn to block 20 below. If the user does not determine that any of the available good transfer options are compatible with the good transfer request, the user may continue browsing to see if any available good transfer options have been added, browse available good transfer options at a subsequent time period, or cease browsing altogether.

Another exemplary implementation where a good transferor and a user agree to transfer one or more goods will be described where the good transferor may be capable of transferring one or more goods in accordance with the good transferor's available good transfer option information. In this example, the good transferor's available good transfer option information may include being able to transfer one or more goods with a gross weight of four thousand pounds or less, a total width of seven feet or less, a total height of seven feet or less, availability allowing transfer of the one or more goods within three days, good transfer requirements/limitations (e.g., a longest good of the one or more goods must have a length of seven feet or less, a weight of the one or more goods must be four thousand pounds or less, and a total height of the one or more goods must be seven feet or less), good transfer space characteristics (e.g., a length (fifteen feet), a width (seven feet and eight inches), a height (seven feet and two inches), and a material (fiberglass reinforced plywood (FRP) of a transfer space that may carry the one or more goods), good transfer pricing (e.g., $1,500 for up to four thousand pounds), and good transfer distance limitations (e.g., total transfer distance must be less than thirty miles). The good transferor may access the good transfer platform and may use the good transferor device to send an available good transfer option request including the associated available good transfer option information to the good transfer platform (as described above).

The good transferor may browse good transfer requests presented by the good transfer platform via the good transferor device to determine whether any of the good transfer requests are compatible with the available good transfer option of the good transferor where a good transfer request is compatible with the available good transfer option of the good transferor when the good transfer request can meet all requirements of the available good transfer option of the good transferor.

In this example, a first good transfer request may include good transfer request information such as, for example, a type of the one or more goods (e.g., metal pieces), a length of the longest metal piece (e.g., six feet feet), a total width of the metal pieces (e.g., six feet), a total height of the metal pieces (e.g., seven feet) a gross weight of the metal pieces (i.e., four thousand pounds), a quantity (i.e., three hundred), a required transfer deadline (e.g., the metal pieces must be delivered within three days), a pick-up location (e.g., a business address), a drop-off location (e.g., a home address), a total transfer distance (20 miles), and a budget (e.g., $1500 or less).

In this example, a second good transfer request may include good transfer request information such as, for example, a type of the one or more goods (e.g., metal pieces), a length of the longest metal piece (e.g., eight feet feet), a total width of the metal pieces (e.g., seven feet), a total height of the metal pieces (e.g., seven feet and six inches) a gross weight of the metal pieces (i.e., five thousand pounds), a quantity (i.e., three hundred), a required transfer deadline (e.g., the metal pieces must be delivered after three days and before one week), a pick-up location (e.g., a business address), a drop-off location (e.g., a home address), a total transfer distance (40 miles), and a budget (e.g., $1000 or less).

In this example, the first good transfer request would be compatible with the available good transfer option of the good transferor and the second good transfer request would be incompatible with the available good transfer option of the good transferor. Accordingly, the good transferor may determine that the first good transfer request is compatible with the available good transfer option of the good transferor and the method 10 may turn to block 20 below. If the good transferor does not determine that any of the good transfer requests are compatible with the available good transfer option of the good transferor, the good transferor may continue browsing to see if any good transfer requests have been added, browse good transfer requests at a subsequent time period, or cease browsing altogether.

At 20, a user may select the compatible available good transfer option or the good transferor may select the compatible good transfer request to transfer the one or more goods associated with the good transfer request. For example, if the user determines that the first available good transfer option is compatible with the good transfer request, the user may select the compatible available good transfer option to transfer the one or more goods associated with the good transfer request, or if the good transferor may determine that the first good transfer request is compatible with the available good transfer option of the good transferor, the good transferor may select the compatible good transfer request to transfer the one or more goods associated with the good transfer request.

An exemplary implementation where a user determines that an available good transfer option is compatible with the good transfer request will be described; however, another implementation where the good transferor determines that the first good transfer request is compatible with the available good transfer option of the good transferor may follow substantially similar steps.

If the compatible available good transfer option includes a presented price (e.g., displayed on the user device), the user may enter an input, via the user device, that indicates a request to select the compatible available good transfer option at the presented price and the user device may send the input to the good transfer platform. The good transfer platform may process the input from the user device and may send a confirmation notification to the user device and a good transferor associated with the selected compatible available good transfer option.

If the compatible available good transfer option does not include a presented price, or if the presented price is a general budget, the user may make an offer of an amount of money to the good transferor (i.e., through the good transfer platform) and the good transferor may accept, reject, or make a counteroffer to the user until an agreement between the user and good transferor has been reached (and a confirmation notification may be sent to the user and the good transferor) or until negotiations are discontinued (and no confirmation notification is sent to the user and the good transferor.

At 22, the good transfer platform may provide pre-pickup information to the user and/or the good transferor (e.g., the good transfer platform pay provide reminders, updates, and/or any other suitable information to the user and/or the good transferor). For example, on the day of the transfer, which may be the same day as the confirmation or a day subsequent to the confirmation, the good transfer platform may send a reminder to the good transferor a time period before the agreed upon time for pick-up. The good transfer platform may determine a location of the good transferor and a location of the pick-up location. For example, the good transfer platform may use geographical locators (e.g., GPS, cloud-based map applications, etc.) to determine the locations of the good transferor and/or the drop-off location. The good transfer platform may determine pick-up times based on a real-time location of the good transferor and the location of the pick-up location and may send updates to the user indicating a real-time time of arrival of the good transferor.

At 24, the good transferor may arrive at the pick-up location of the one or more goods of the user and the good transfer platform may send a notification to the user device indicating that the one or more goods has been picked up for transfer.

At 26, the good transferor may transfer the one or more goods from the pick-up location to the drop-off location and the good transfer platform may send a notification to the user device indicating that the one or more goods has been transferred to the drop-off location. The good transfer platform may provide real-time updates on the progress of the transfer to the user. For example, the good transfer platform may determine real-time drop-off times based on a location of the good transferor and a location of the drop-off location. Once the transfer has been completed, the good transfer platform may provide a real-time completion update to the user.

At 28, the user and/or the good transferor may rate a transfer process experience. For example, the user may rate a service level (e.g., performance) of the good transferor and the good transferor may rate a behavior of the user (e.g., provides concise details). For example, the good transfer platform may send a rating survey (e.g., a well-known five (or any number of) stars system for rating) to the user and/or the good transferor requesting the user and/or the good transferor to provide a rating and the good transfer platform may process the provided ratings to be stored within a ratings database. Accordingly, the ratings database may include ratings of good transferors and/or users that may be presented to good transferors and users using the good transfer platform to aid the good transferor and/or the user in determining who to work with in the transfer process.

At 30, the user may provide a payment to the good transferor through the good transfer platform. For example, upon completion of the transfer, the good transfer platform may send a payment due notification to the user and the user may provide the payment (e.g., via a credit card, a cloud-based payment application, electronic check, etc.) to the good transferor through the good transfer platform. The good transfer platform may provide a payment notification to the good transferor upon processing the payment made by the user.

While FIG. 1 illustrates various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

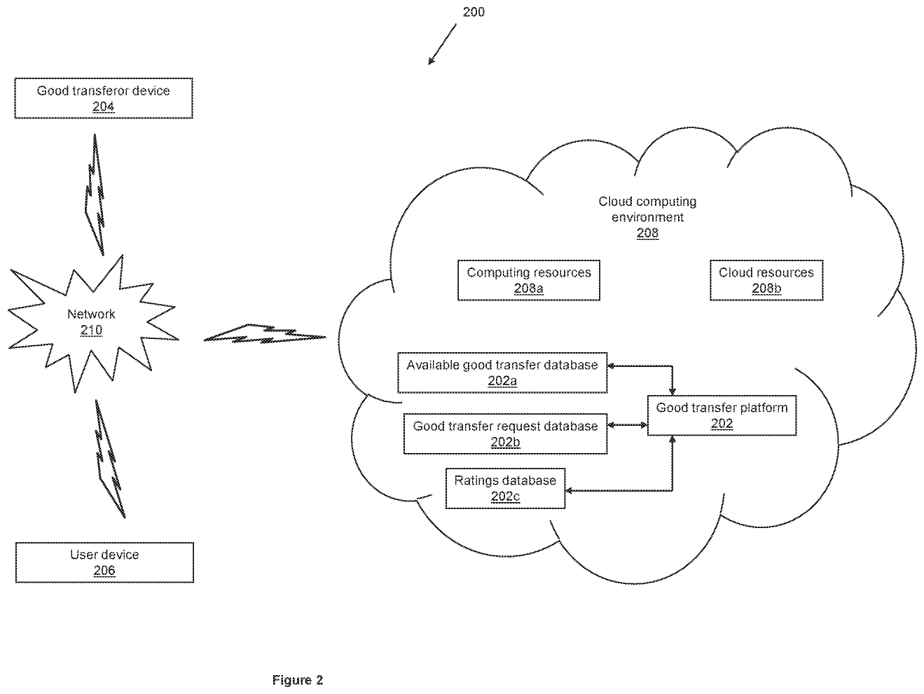

FIG. 2 illustrates an exemplary good transfer system 200 in accordance with one aspect of the present disclosure. The good transfer system 200 may include a good transfer platform 202, a good transferor device 204, and a user device 206. The good transfer system 200 may be implemented within an exemplary cloud computing environment 208 and each of the components of the system may communicate with one another over a network 210.

The good transfer platform 202 may be a server, a computing device, a cloud server, a cloud computing device and/or the like. The good transfer platform may receive, generate, store, process, and/or provide information associated with transferring one or more goods. The good transfer platform 202 may include an available good transfer option database 202a, good transfer request database 202b, and a ratings database 202c.

The good transferor device 204 may be a computing device such as, for example, a mobile phone, a smartphone, a computer and/or the like. The good transferor device may interact with the good transfer platform to transfer one or more goods. For example, the good transferor device may send information to, and receive information from, the good transfer platform to transfer one or more goods.

The user device 206 may be a computing device such as, for example, a mobile phone, a smartphone, a computer and/or the like. The user device may interact with the good transfer platform to transfer one or more goods. For example, the user device may send information to, and receive information from, the good transfer platform to transfer one or more goods.

The cloud computing environment 208 may host the good transfer platform 202. The cloud computing environment 208 may include computing resources 208a and cloud resources 208b. Exemplary computing resources 208a may include computers, servers, storage devices, and/or any other suitable computing devices. Exemplary cloud resources 208b may include applications (e.g., software associated with the good transfer platform 206) accessible by the good transferor device 204 and the user device 206, virtual machines, virtual storage, and/or any other suitable cloud resource.

The network 210 may be any suitable combination of one or more wired and/or wireless networks. For example, network 210 may include any one or more of the Internet, an intranet, a cloud network, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network.

While a particular configuration of the good transfer system 200 and a particular implementation environment associated with the good transfer system 200 have been described, the good transfer system 200 may take on any suitable configuration (e.g., a combination of a bus, one or more processors, a memory, a storage component, an input component, an output component, and a communication interface) and may be implemented within any suitable environment (e.g., a non-cloud-based environment).

The good transfer platform 202, the good transferor device 204, and the user device 206 may communicate with one another over the network 210 to facilitate a transfer of one or more goods from one location to another location (e.g., by implementing the method 10 described above within the good transfer system 200).

In some implementations, the systems and methods of the present disclosure may be used to transfer goods within a relatively localized area (e.g., within cities, within counties, within states, etc.).

In some implementations, the goods to be transferred may have an overall length of fourteen feet or less.

In some implementations, the good transferors transfer goods according to local residential regulations, and, as such, the good transferors do not need commercial driver licenses (CDLs).

In some implementations, the users may be residents of a neighborhood and/or local business (e.g., restaurants).

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

As used herein, an “operable connection” or “operable coupling,” or a connection by which entities are “operably connected” or “operably coupled” is one in which the entities are connected in such a way that the entities may perform as intended. An operable connection may be a direct connection or an indirect connection in which an intermediate entity or entities cooperate or otherwise are part of the connection or are in between the operably connected entities. In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel, and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A good transfer method, comprising:
obtaining, from a good transferor device of a good transferor at a good transfer platform, an available good transfer option including transferor information, the transferor information including transferor availability and dimensions of a good transfer space;
obtaining, from a user device of a user at the good transfer platform, a good transfer request including good information, the good information including one or more goods to be transferred from a pick-up location to a drop-off location, dimensions of the one or more goods, and a pick-up time associated with the one or more goods;
presenting, via the good transfer platform and the user device, the available good transfer option to the user;
obtaining, from the user device of the user at the good transfer platform, a selection of the available good transfer option to fulfill the good transfer request;
wherein the selection of the available good transfer option is based, at least in part, on the available good transfer option being compatible with the good transfer request; and
notifying, via the good transfer platform and the good transferor device, the good transferor of the pick-up location, the pick-up time, and the drop-off location of the good information of the good transfer request.

2. The method of claim 1, further comprising:
before the presenting, via the good transfer platform and the user device, the available good transfer option to the user occurs, determining, via the good transfer platform, that the available good transfer option is a compatible available good transfer option based, at least in part, on the available good transfer option being compatible with the good transfer request; and
presenting, via the good transfer platform and the user device, the compatible available good transfer option to the user.

3. The method of claim 1, further comprising:
determining, via the good transfer platform and the good transferor device, that the one or more goods associated with the good transfer request have been transferred to the drop-off location;
providing, via the good transfer platform at the user device, a rating survey to the user requesting the user to rate a transfer experience; and
obtaining, via the user device at the good transfer platform, a rating of the transfer experience.

4. The method of claim 1, further comprising:
effecting, via the user device at the good transfer platform, a payment made by the user to the good transferor.

5. The method of claim 1, wherein the transferor information includes a transfer limitation associated with the good transfer space, the transfer limitation being based, at least in part, on residential transfer requirements.

6. The method of claim 5, wherein the residential transfer requirement is a weight limit associated with the good transfer space, the weight limit being less than 10,001 pounds.

7. The method of claim 1, further comprising:
using a cloud-based application as the good transfer platform.

8. A good transfer method, comprising:
obtaining, from a good transferor device of a good transferor at a good transfer platform, an available good transfer option including transferor information, the transferor information including transferor availability and dimensions of a good transfer space;
obtaining, from a user device of a user at the good transfer platform, a good transfer request including good information, the good information including one or more goods to be transferred from a pick-up location to a drop-off location, dimensions of the one or more goods, and a pick-up time associated with the one or more goods;
presenting, via the good transfer platform and the user device, the good transfer request to the good transferor;
obtaining, from the good transferor device of the good transferor at the good transfer platform, a selection of the good transfer request to be fulfilled by the good transferor; wherein the selection of the good transfer request is based, at least in part, on the good transfer request being compatible with the available good transfer option; and
notifying, via the good transfer platform and the good transferor device, the good transferor of the pick-up location and the pick-up time of the good information of the good transfer request.

9. The method of claim 8, further comprising:
before the presenting, via the good transfer platform and the good transferor device, the good transfer request to the good transferor occurs, determining, via the good transfer platform, that the good transfer request is a compatible good transfer request based, at least in part, on the good transfer request being compatible with the available good transfer option; and
presenting, via the good transfer platform and the good transferor device, the compatible good transfer request to the good transferor.

10. The method of claim 8, further comprising:
determining, via the good transfer platform and the good transferor device, that the one or more goods associated with the good transfer request have been transferred to the drop-off location;
providing, via the good transfer platform at the user device, a rating survey to the user requesting the user to rate a transfer experience; and
obtaining, via the user device at the good transfer platform, a rating of the transfer experience.

11. The method of claim 8, further comprising:
effecting, via the user device at the good transfer platform, a payment made by the user to the good transferor.

12. The method of claim 8, wherein the transferor information includes a transfer limitation associated with the good transfer space, the transfer limitation being based, at least in part, on residential transfer requirements.

13. The method of claim 12, wherein the residential transfer requirement is a weight limit associated with the good transfer space, the weight limit being less than 10,001 pounds.

14. The method of claim 8, further comprising:
using a cloud-based application as the good transfer platform.

15. A good transfer system, comprising:
a good transfer platform;
a good transferor device; and
a user device; the good transfer platform being configured to:
obtain, from the good transferor device of a good transferor at the good transfer platform, an available good transfer option including transferor information, the transferor information including transferor availability and dimensions of a good transfer space;
obtain, from the user device of a user at the good transfer platform, a good transfer request including good information, the good information including one or more goods to be transferred from a pick-up location to a drop-off location, dimensions of the one or more goods, and a pick-up time associated with the one or more goods;
present, via the good transfer platform and the user device, the available good transfer option to the user;
obtain, from the user device of the user at the good transfer platform, a selection of the available good transfer option to fulfill the good transfer request;
wherein the selection of the available good transfer option is based, at least in part, on the available good transfer option being compatible with the good transfer request; and
notify, via the good transfer platform and the good transferor device, the good transferor of the pick-up location, the pick-up time, and the drop-off location of the good information of the good transfer request.

16. The system of claim 15, wherein the good transfer platform is configured to:
before presenting, via the good transfer platform and the user device, the available good transfer option to the user occurs, determining, via the good transfer platform, that the available good transfer option is a compatible available good transfer option based, at least in part, on the available good transfer option being compatible with the good transfer request; and
presenting, via the good transfer platform and the user device, the compatible available good transfer option to the user.

17. The system of claim 15, wherein the good transfer platform is configured to:
determine, via the good transfer platform and the good transferor device, that the one or more goods associated with the good transfer request have been transferred to the drop-off location;
provide, via the good transfer platform at the user device, a rating survey to the user requesting the user to rate a transfer experience; and
obtain, via the user device at the good transfer platform, a rating of the transfer experience.

18. The system of claim 15, wherein the good transfer platform is configured to:
effect, via the user device at the good transfer platform, a payment made by the user to the good transferor.

19. The system of claim 15, wherein the transferor information includes a transfer limitation associated with the good transfer space, the transfer limitation being based, at least in part, on residential transfer requirements.

20. The system of claim 19, wherein the residential transfer requirement is a weight limit associated with the good transfer space, the weight limit being less than 10,001 pounds.
